(19) United States
(12) Patent Application Publication
(10) Pub. No.: US 2023/0348690 A1
(43) Pub. Date: Nov. 2, 2023

(54) TRANSPARENT ELECTRICALLY CONDUCTIVE EPOXY RESIN AND ELECTROSTATIC DISSIPATIVE FLOOR

(71) Applicant: SIKA TECHNOLOGY AG, Baar (CH)

(72) Inventors: Oguz SARIOGLU, Heilbronn (DE); Jochen GRÖTZINGER, Schwäbisch Gmünd (DE); Thomas PUSEL, Hemmingen (DE); Uwe VON DER BRÜGGEN, Meckesheim (DE); Michael BYRNE, Lytham (GB)

(73) Assignee: SIKA TECHNOLOGY AG, Baar (CH)

(21) Appl. No.: 18/019,208

(22) PCT Filed: Aug. 31, 2021
(86) PCT No.: PCT/EP2021/074015

§ 371 Date: Feb. 1, 2023

(30) Foreign Application Priority Data
Sep. 1, 2020 (EP) 20193950.1

(51) Int. Cl. C09D 5/24; C08K 3/04; C09D 7/61; C09D 163/00

(52) U.S. Cl. CPC C08K 3/041; C09D 5/24; C09D 7/61; C09D 163/00; C08K 2201/001

(57) ABSTRACT

The use of a combination of carbon nanotubes and at least one zinc oxide, more particularly an aluminium-doped zinc oxide, for producing a transparent, electrically conductive epoxy resin coating, and an electrostatic dissipative floor system which is sealed with the clear, electrically conductive epoxy resin coating that permits aesthetically attractive, transparently sealed, electrostatic dissipative epoxy resin floor systems, onto which more particularly conductive silica sand is scattered, the floor systems thus being particularly slip-resistant, wherein the structure and color of the sand is well visible through the transparent seal.

### TECHNICAL FIELD

The invention relates to electrically conductive epoxy resin coatings and to the use thereof in electrostatically dissipative floors.

### PRIOR ART

Electrostatically dissipative floors, also called ESD floors, are known. They serve to dissipate electrostatic charges that arise in a room, for example as a result of foot traffic or wheeled traffic, via footwear and the floor to a grounding. This avoids spontaneous electrostatic discharges which can lead to defects or faults in the production or handling of sensitive products or instruments.

An electrostatically dissipative floor must have sufficiently low electrical resistance to ground that charges are reliably dissipated, but must only be dissipative to such a degree that there is no risk to the health of persons in the event of contact with electrical current. There are standards for such floors that described test methods for electrostatic and electrical characteristics. DIN EN 61340-4-1 described, for example, a test method for determination of the electrical resistance of floor coverings and laid floors, and DIN EN 61340-4-5 assesses electrical safety with regard to electrical resistance and the degree to which people, footwear and floor coverings can become charged in combination.

Epoxy resin-based floors are particularly robust in relation to mechanical stress and stability toward many substances. They are therefore particularly suitable for highly demanding industrial production rooms. An epoxy resin-based electrostatically dissipative floor system must achieve a series of properties. It is to form reliable adhesion on different substrates and be installable with minimum complexity. The electrostatic charges absorbent by the floor are to be reliably dissipated downward. For this purpose, what is called a conductor system comprising copper ribbons or wires connected to a grounding is laid beneath the coating. The epoxy resin coating is to be readily installable and compatible with the underlying conductor system and, after curing, is to have an esthetically pleasing uniform surface with high hardness coupled with low brittleness. For this purpose, the epoxy resin coating is to have low viscosity with good leveling and good deaeration and a long open time at ambient temperature, but is nevertheless to cure very rapidly and is not to form any hardening faults such as residual tack, specks or cloudiness. For high slip resistance, a sand may be scattered onto the surface, covered with a seal. After the curing, the coated floor is to have an electrical resistance in the range from about 10⁵ to 10⁸ ohms and is to be robust and durable.

Floors made from synthetic resins such as epoxy resins are insulators. There are various ways of achieving electrical conductivity. A known way is to use ionic liquids or of organic salts soluble in the synthetic resin matrix, which provide electrical conductivity. But this slows down curing and severely reduces the mechanical and chemical durability of the floor, and electrical resistance is highly dependent on the current humidity. In addition, conductive solid particles may be added. Suitable examples for this purpose are metals, but these have a strong intrinsic color and, on account of their high specific weight, during the storage of the still-liquid composition, settle to such a degree at the base of the container that homogeneous stirring-up and distribution in the coating is difficult. This leads to nonuniform electrical resistance and zones that have too low a conductivity. Also known is the addition of conductive carbon black or graphite, which does achieve a reliable conductivity, but only very dark to black coatings are obtained owing to the strong black color of these substances, which is usually undesirable for an industrial floor. Also known are fine fibers made of carbon, called carbon fibers. But these likewise present difficulties in homogeneous mixing and tend to accumulate, which remains visible after curing and leads to unattractive surfaces with nonuniform resistance. Likewise known are doped mineral fillers, for example aluminum-doped zinc oxide. They sink to a lesser degree than metal powders. However, the electrical conductivity thereof is relatively low, they are costly, and large amounts are needed to obtain good electrical conductivity. As of recently, carbon nanotubes (CNTs) are known, which are also usable as conductive fillers. These are nanotubes made of carbon, the wall of which consists of individual graphite layers, called graphenes. Carbon nanotubes, even when a very small amount is used, already enable good conductivity with uniform resistance over a large area, largely independently of humidity. On account of their high surface area, however, they have a significantly thickening action and they impart a dark color to a composition in spite of a very small use amount in terms of weight. This dark colour can be compensated for by the use of light colour pigments, such as titanium dioxide in particular, such that floors in light shades are also obtainable. However, the use of pigments prevents the formulation of transparent coatings. The prior art to date does not include any transparent, electrically conductive epoxy resin coating suitable for transparent sealing of electrostatically dissipative floors, especially of surfaces that have been scattered with sand and have a faultless look and reliable conductivity largely irrespective of air humidity. Epoxy resin-based electrostatically dissipative floors are described, for example, in EP 1,437,182, where carbon fibres are used as conductive fillers.

### SUMMARY OF THE INVENTION

It is therefore an object of the present invention to provide a transparent, electrically conductive epoxy resin coating having electrical resistance largely independent of humidity and a faultless, esthetically pleasing surface, which is suitable as a constituent of an electrostatically dissipative floor system, especially as transparent seal of surfaces scattered with sand.

Surprisingly, this object is achieved by the use of a combination of carbon nanotubes and at least one zinc oxide as described in claim 1. The inventive use enables transparently sealed, electrostatically dissipative floor systems having a faultless surface and electrical resistance largely independent of humidity. Carbon nanotubes alone do achieve reliable electrical conductivity, but the result is an unwanted dark shade which is too dark for transparent coating. An aluminum-doped zinc oxide does enable electrical conductivity, but for this purpose has to be used in such a large amount that it gives rise to an unwanted whitish, nontransparent appearance. Surprisingly, the use of a combination of carbon nanotubes and at least one zinc oxide, especially an aluminum-doped zinc oxide, enables good electrical conductivity coupled with high transparency, wherein the lightening effect of zinc oxide compensates surprisingly well for the darkening by the carbon nanotubes, especially in the preferred amounts. The inventive use thus enables transparent, electrically conductive epoxy resin coatings having good storage stability and good workability, especially as self-leveling and/or roller-applied liquids having good leveling and good deaeration, and reliable, rapid curing coupled with sufficiently long pot life. After curing, the coating has homogeneous electrical resistance, largely independent of humidity, a highly esthetic, mechanically and chemically highly durable surface without inhomogeneities such as streaks, specks, cloudiness or craters, good adhesion on many substrates, especially also on sand particles, and such high transparency that the color and structure of the sand and the underlying coating are still of good visibility after the coating. Such a coating is particularly suitable as a transparent seal for electrostatically dissipative floors that have been scattered with electrically conductive quartz sand. The inventive use especially also enables transparent coatings having particularly low emission of organic substances after curing, which are suitable for use in hospitals or cleanrooms.

Electrostatically dissipative floor systems having a transparently sealed surface scattered with sand are esthetically pleasing, durable, easy to clean and enable particularly good slip prevention. The sealing protects the surface from excessive wear and the breaking-away of sand particles under mechanical stress.

Further aspects of the invention are the subject of further independent claims. Particularly preferred embodiments of the invention are the subject of the dependent claims.

### WAYS OF EXECUTING THE INVENTION

The invention provides for the use of a combination of carbon nanotubes and at least one zinc oxide for production of a transparent, electrically conductive epoxy resin coating.

“Carbon nanotubes” refer to carbon tubes having a diameter in the nanometer range, especially in the range from 1 to 50 nm, and a wall composed of one or more plies of graphene, i.e. carbon having carbon atoms arranged in rings.

A “doped” zinc oxide refers to one in which small amounts of extraneous ions have been introduced that are not naturally present and change the electrical properties of the zinc oxide.

A “storage stable” composition refers to one that can be stored at room temperature in a suitable container over a prolonged period, typically over at least 3 months up to 6 months or more, without this storage resulting in any change in its application or use properties to an extent relevant to its use.

A “thinner” refers to a substance that is soluble in an epoxy resin and lowers its viscosity, and that is not chemically incorporated into the epoxy resin polymer during the curing process.

“Liquid epoxy resin” refers to an industrial polyepoxide having a glass transition temperature below 25° C.

“Molecular weight” refers to the molar mass (in grams per mole) of a molecule. “Average molecular weight” refers to the number average Mₙ of a polydisperse mixture of oligomeric or polymeric molecules. It is determined by gel-permeation chromatography (GPC) against polystyrene as standard.

“Pot life” refers to the period of time from the mixing of the components of an epoxy resin composition within which the composition can be processed without losses.

The “gel time” is the time interval from mixing the components of an epoxy resin composition until the gelation thereof.

A “primary amino group” refers to an amino group that is attached to a single organic radical and bears two hydrogen atoms; a “secondary amino group” refers to an amino group that is attached to two organic radicals that may also together be part of a ring and bears one hydrogen atom; and a “tertiary amino group” refers to an amino group that is attached to three organic radicals, two or three of which may also be part of one or more rings, and does not bear any hydrogen atom. “Amine hydrogen” refers to the hydrogen atoms of primary and secondary amino groups.

“Amine hydrogen equivalent weight” refers to the mass of an amine or an amine-containing composition that contains one molar equivalent of amine hydrogen. Substance names beginning with “poly”, such as polyamine or polyepoxide, refer to substances that formally contain two or more of the functional groups that occur in their name per molecule.

“Room temperature” refers to a temperature of 23° C.

Percentages by weight (% by weight), abbreviated to wt%, refer to proportions by mass of a constituent of a composition or a molecule, based on the overall composition or the overall molecule, unless stated otherwise. The terms “mass” and “weight” are used synonymously in the present document.

All industry standards and norms mentioned in this document relate to the versions valid at the date of first filing.

Carbon nanotubes are produced industrially and are supplied commercially in various qualities. They have properties of interest for different areas of use. In particular, they are electrically conductive.

Suitable carbon nanotubes are especially what are called single wall carbon nanotubes.

They are preferably used in the form of a dispersion in a liquid carrier material, especially in a liquid having good compatibility with epoxy resin compositions, especially an alkyl glycidyl ether, a fatty acid ester or an ethoxylated alcohol.

Preference is given to a dispersion comprising 10% by weight of carbon nanotubes, especially in an alkyl glycidyl ether, especially a C₁₂ to C₁₄ alkyl glycidyl ether, as also used as reactive diluent for epoxy resins. Such a dispersion is commercially available, for example as Tuball® Matrix 207 (from OCSiAl).

Even a very small amount of carbon nanotubes by weight enables good electrical conductivity, but also brings about distinct darkening of the coating and a significant increase in viscosity.

Preference is given to using a very small amount of carbon nanotubes.

Preference is given to an amount of carbon nanotubes in the range from 0.001% to 0.01% by weight based on the overall epoxy resin coating.

Particular preference is given to an amount in the range from 0.001% to 0.005% by weight, especially 0.001% to 0.003% by weight, based on the overall epoxy resin coating.

Thus, a dispersion comprising 10% by weight of carbon nanotubes is used, preferably in an amount in the range from 0.01% to 0.1% by weight, more preferably 0.01% to 0.05% by weight, especially 0.01% to 0.03% by weight, based on the overall epoxy resin coating.

Within this range, in combination with zinc oxide, good transparency and the desired electrical conductivity are achieved.

The zinc oxide is preferably a fine powder. The powder preferably has a particle size in the range from 0.1 to 100 µm, more preferably 0.1 to 50 µm, especially 0.1 to 10 µm. Such a powder is also referred to as filler. As a powder, it is white in color; in fine distribution, it has high transparency and a lightening effect.

The zinc oxide has preferably been doped with at least one further metal. Zinc oxide naturally has only low electrical conductivity, which is increased by the doping.

Especially suitable for doping is aluminum, antimony, tellurium, tungsten or indium. Preference is given to aluminum. This doping is particularly advantageous for reasons of cost and toxicity.

Particular preference is thus given to an aluminum-doped zinc oxide. This is readily obtainable and of low toxicity, and in combination with the carbon nanotubes enables epoxy resin coatings having high transparency and good electrical conductivity.

The aluminum-doped zinc oxide preferably contains not more than 5% by weight of aluminum oxide and at least 95% by weight of zinc oxide.

A suitable aluminum-doped zinc oxide is commercially available, for example as ZnO-23K (from Itochu).

The Zinc oxide, especially aluminum-doped zinc oxide, is preferably used in an amount in the range from 0.5% to 5% by weight, based on the overall epoxy resin coating.

Particular preference is given to an amount in the range from 1% to 3% by weight. Within this range, good transparency and conductivity are enabled together with the carbon nanotubes.

Particular preference is given to using the carbon nanotubes in an amount in the range from 0.001% to 0.005% by weight, especially 0.001% to 0.003% by weight, and zinc oxide in an amount in the range from 0.5% to 5% by weight, especially 1% to 3% by weight.

Preference is given to a weight ratio between the carbon nanotubes and the zinc oxide in the range from 1/500 to 1/1500, especially 1/700 to 1/1300.

Preference is given to additionally using at least one electrically conductive quartz sand as well as the carbon nanotubes and the zinc oxide. A suitable electrically conductive quartz sand is a quartz sand coated with an electrically conductive synthetic resin, especially having a grain size in the range from 0.1 to 1.3 mm. Such quartz sands are commercially available, for example as Granucol® Conduct 2.0 (from Dorfner).

In particular, a cured surface having protruding sand particles that has been scattered with electrically conductive quartz sand is blanketed and sealed here with the transparent epoxy resin coating of the invention, with good visibility of the structure and color of the sand through the transparent seal and achievement of a highly esthetic appearance coupled with good electrical conductivity.

The invention further provides an electrically conductive epoxy resin coating resulting from the use described, comprising
at least one liquid epoxy resin,
at least one hardener for epoxy resins,
carbon nanotubes, and
at least zinc oxide.

Suitable liquid epoxy resins are especially aromatic epoxy resins, especially the glycidyl ethers of:
bisphenol A, bisphenol F or bisphenol A/F, where A stands for acetone and F for formaldehyde used as reactants in the production of these bisphenols. In the case of bisphenol F, positional isomers may also be present, more particularly ones derived from 2,4′or 2,2′-hydroxyphenylmethane.
dihydroxybenzene derivatives such as resorcinol, hydroquinone or catechol;
further bisphenols or polyphenols such as bis(4-hydroxy-3-methylphenyl)methane, 2,2-bis(4-hydroxy-3-methylphenyl)propane (bisphenol C), bis(3,5-dimethyl-4-hydroxyphenyl)methane, 2,2-bis(3,5-dimethyl-4-hydroxyphenyl)propane, 2,2-bis(3,5-dibromo-4-hydroxyphenyl)propane, 2,2-bis(4-hydroxy-3-tert-butylphenyl)propane, 2,2-bis(4-hydroxyphenyl)butane (bisphenol B), 3,3-bis(4-hydroxyphenyl)pentane, 3,4-bis(4-hydroxyphenyl)hexane, 4,4-bis(4-hydroxyphenyl)heptane, 2,4-bis(4-hydroxyphenyl)-2-methylbutane, 2,4-bis(3,5-dimethyl-4-hydroxyphenyl)-2-methylbutane, 1,1-bis(4-hydroxyphenyl)cyclohexane (bisphenol Z), 1,1-bis(4-hydroxyphenyl)-3,3,5-trimethylcyclohexane (bisphenol TMC), 1,1-bis(4-hydroxyphenyl)-1-phenylethane, 1,4-bis[2-(4-hydroxyphenyl)-2-propyl]benzene (bisphenol P), 1,3-bis[2-(4-hydroxyphenyl)-2-propyl]benzene (bisphenol M), 4,4′-dihydroxydiphenyl (DOD), 4,4′-dihydroxybenzophenone, bis(2-hydroxynaphth-1-yl)methane, bis(4-hydroxynaphth-1-yl)methane, 1,5-dihydroxynaphthalene, tris(4-hydroxyphenyl)methane, 1,1,2,2-tetrakis(4-hydroxyphenyl)ethane, bis(4-hydroxyphenyl) ether or bis(4-hydroxyphenyl) sulfone;
novolaks, which are especially condensation products of phenol or cresols with formaldehyde;
aromatic amines such as aniline, toluidine, 4-aminophenol, 4,4′-methylenediphenyldiamine, 4,4′-methylenediphenyldi(N-methyl)amine, 4,4′-[1,4-phenylenebis(1-methylethylidene)]bisaniline (bisaniline P) or 4,4′-[1,3-phenylenebis(1-methylethylidene)]bisaniline (bisaniline M).

Further suitable epoxy resins are aliphatic or cycloaliphatic polyepoxides, especially
glycidyl ethers of saturated or unsaturated, branched or unbranched, cyclic or open-chain di-, trior tetrafunctional C₂ to C₃₀ alcohols, especially ethylene glycol, propylene glycol, butylene glycol, hexanediol, octanediol, polypropylene glycols, dimethylolcyclohexane, neopentyl glycol, dibromoneopentyl glycol, castor oil, trimethylolpropane, trimethylolethane, pentaerythritol, sorbitol or glycerol, or alkoxylated glycerol or alkoxylated trimethylolpropane;
a hydrogenated bisphenol A, F or A/F liquid resin, or the glycidylation products of hydrogenated bisphenol A, F or A/F;
an N-glycidyl derivative of amides or heterocyclic nitrogen bases, such as triglycidyl cyanurate or triglycidyl isocyanurate, or reaction products of epichlorohydrin with hydantoin.

Particular preference is given to aromatic diepoxides that are liquid at room temperature and have an epoxy equivalent weight in the range from 110 to 200 g/mol, preferably 150 to 200 g/mol, especially bisphenol A diglycidyl ether and/or bisphenol F diglycidyl ether, as commercially available, for example, from Olin, Huntsman or Momentive. These liquid resins enable rapid curing and high hardnesses.

Together with the liquid epoxy resin, the coating may contain proportions of solid bisphenol A resin or novolak glycidyl ethers or reactive diluents.

Suitable reactive diluents are especially butanediol diglycidyl ether, hexanediol diglycidyl ether, trimethylolpropane di- or triglycidyl ether, phenyl glycidyl ether, cresyl glycidyl ether, guaiacol glycidyl ether, 4-methoxyphenyl glycidyl ether, p-n-butylphenyl glycidyl ether, p-tert-butylphenyl glycidyl ether, 4-nonylphenyl glycidyl ether, 4-dodecylphenyl glycidyl ether, cardanol glycidyl ether, benzyl glycidyl ether, allyl glycidyl ether, butyl glycidyl ether, hexyl glycidyl ether, 2-ethylhexyl glycidyl ether, or glycidyl ethers of natural alcohols, such as in particular C₈ to C₁₀ or C₁₂ to C₁₄ or C₁₃ to C₁₅ alkyl glycidyl ethers.

Suitable hardeners for epoxy resins are especially amines having at least two amine hydrogens.

Preference is given to amines having at least three amine hydrogens or mixtures of amines containing at least one amine having at least three, preferably at least four, amine hydrogens.

Preference is given to amines having aliphatic amino groups, i.e. amino groups bonded to an aliphatic carbon atom.

Suitable amines having aliphatic amino groups are especially N-benzylethane-1,2-diamine, N-benzylpropane-1,2-diamine, N-benzyl-1,3-bis(aminomethyl)benzene, N-(2-ethylhexyl)-1,3-bis(aminomethyl)benzene, N-(2-phenylethyl)-1,3-bis(aminomethyl)benzene, 2,2-dimethylpropane-1,3-diamine, pentane-1,3-diamine (DAMP), pentane-1,5-diamine, 1,5-diamino-2-methylpentane (MPMD), 2-butyl-2-ethylpentane-1,5-diamine (C11-neodiamine), hexane-1,6-diamine, 2,5-dimethylhexane-1,6-diamine, 2,2(4),4-trimethylhexane-1,6-diamine (TMD), heptane-1,7-diamine, octane-1,8-diamine, nonane-1,9-diamine, decane-1,10-diamine, undecane-1,11-diamine, dodecane-1,12-diamine, 1-amino-3-aminomethyl-3,5,5-trimethylcyclohexane (IPDA), 1,2-diaminocyclohexane, 1,3-diaminocyclohexane, 1,4-diaminocyclohexane, 1,3-bis(aminomethyl)cyclohexane, 1,4-bis(aminomethyl)cyclohexane, bis(4-aminocyclohexyl)methane, bis(4-amino-3-methylcyclohexyl)methane, bis(4-amino-3-ethylcyclohexyl)methane, bis(4-amino-3,5-dimethylcyclohexyl)methane, bis(4-amino-3-ethyl-5-methylcyclohexyl)methane, 2(4)-methyl-1,3-diaminocyclohexane, 2,5(2,6)-bis(aminomethyl)bicyclo[2.2.1]heptane (NBDA), 3(4),8(9)-bis(aminomethyl)tricyclo[5.2.1.0^{2.6}]decane, 1,4-diamino-2,2,6-trimethylcyclohexane (TMCDA), menthane-1,8-diamine, 3,9-bis(3-aminopropyl)-2,4,8,10-tetraoxaspiro[5.5]undecane, 1,3-bis(aminomethyl)benzene (MXDA), 1,4-bis(aminomethyl)benzene, bis(2-aminoethyl) ether, 3,6-dioxaoctane-1,8-diamine, 4,7-dioxadecane-1,10-diamine, 4,7-dioxadecane-2,9-diamine, 4,9-dioxadodecane-1,12-diamine, 5,8-dioxadodecane-3,10-diamine, 4,7,10-trioxatridecane-1,13-diamine or higher oligomers of these diamines, bis(3-aminopropyl)polytetrahydrofurans or other polytetrahydrofurandiamines, polyoxyalkylenediamines or -triamines, especially polyoxypropylenediamines or polyoxypropylenetriamines such as Jeffamine® D-230, Jeffamine® D-400 or Jeffamine® T-403 (all from Huntsman), diethylene triamine (DETA), triethylene tetramine (TETA), tetraethylene pentamine (TEPA), pentaethylene hexamine (PEHA), dipropylene triamine (DPTA), N-(2-aminoethyl)propane-1,3-diamine (N3-amine), N,N′-bis(3-aminopropyl)ethylenediamine (N4-amine), N,N′-bis(3-aminopropyl)-1,4-diaminobutane, N5-(3-aminopropyl)-2-methylpentane-1,5-diamine, N3-(3-aminopentyl)pentane-1,3-diamine, N5-(3-amino-1-ethylpropyl)-2-methylpentane-1,5-diamine, N,N′-bis(3-amino-1-ethylpropyl)-2-methylpentane-1,5-diamine, 3-(2-aminoethyl)aminopropylamine, bis(hexamethylene)triamine (BHMT), N-aminoethylpiperazine, 3-dimethylaminopropylamine (DMAPA) or 3-(3-(dimethylamino)propylamino)propylamine (DMAPAPA), and also further adducts of these polyamines with epoxy resins or monoepoxides, or adducts of ethane-1,2-diamine or propane-1,2-diamine with epoxy resins and subsequent removal of excess ethane-1,2-diamine or propane-1,2-diamine by distillation.

The hardener for epoxy resins is preferably selected from the group consisting of N-benzylethane-1,2-diamine, TMD, IPDA, 1,2-diaminocyclohexane, 1,3-diaminocyclohexane, 1,4-diaminocyclohexane, 1,3-bis(aminomethyl)cyclohexane, 1,4-bis(aminomethyl)cyclohexane, bis(4-aminocyclohexyl)methane, 2(4)-methyl-1,3-diaminocyclohexane, MXDA, polyoxypropylenediamines having an average molecular weight Mₙ within a range from 200 to 500 g/mol, polyoxypropylene triamines having an average molecular weight Mₙ within a range from 300 to 500 g/mol, DMAPAPA, BHMT, DETA, TETA, TEPA, PEHA, DPTA, N3 amine, N4 amine, adducts of N-benzylethane-1,2-diamine, IPDA, MXDA, DETA, TETA or TEPA with epoxy resins, adducts of MPMD, ethane-1,2-diamine or propane-1,2-diamine with cresyl glycidyl ether, in which unreacted MPMD, ethane-1,2-diamine or propane-1,2-diamine were removed by distillation after the reaction, and mixtures of two or more of the amines mentioned.

Among these, preference is given to N-benzylethane-1,2-diamine, IPDA, 1,2-diaminocyclohexane, 1,3-bis(aminomethyl)cyclohexane, 1,4-bis(aminomethyl)cyclohexane, 2(4)-methyl-1,3-diaminocyclohexane, MXDA, polyoxypropylenediamines having an average molecular weight Mₙ within a range from 200 to 500 g/mol, adducts of these amines with epoxy resins, or mixtures of two or more of these amines.

Particular preference is given to N-benzylethane-1,2-diamine and/or adducts thereof with bisphenol A diglycidyl ether. This amine enables particularly good leveling, particularly good deaeration, faultless curing at cold ambient temperatures, particularly pleasing surfaces, particularly high transparency and low brittleness after curing, which promotes high mechanical robustness.

Particular preference is also given to IPDA and/or adducts thereof with bisphenol A diglycidyl ether. These amines enable reliable curing and a particularly high glass transition temperature, which promotes high robustness of the coating at warm ambient temperatures.

Particular preference is also given to 1,3-bis(aminomethyl)cyclohexane. This amine permits particularly rapid curing.

Particular preference is also given to MXDA and/or adducts thereof with bisphenol A diglycidyl ether. These amines permit particularly rapid curing.

Particular preference is also given to polyoxypropylenediamines having an average molecular weight Mₙ in the range from 200 to 500 g/mol. These amines enable low brittleness after curing, which promotes high mechanical robustness.

Most preferably, the hardener comprises a combination of two or more amines selected from IPDA, TMD, N-benzylethane-1,2-diamine and polyoxypropylenediamines having an average molecular weight Mₙ in the range from 200 to 500 g/mol.

The hardener for epoxy resins may contain additional constituents that are reactive with epoxy groups, especially
monoamines or diamines having secondary amino groups, especially N,N′-dibenzylethane-1,2-diamine,
polyamidoamines, especially reaction products of a monoor polybasic carboxylic acid, or the ester or anhydride thereof, especially a dimer fatty acid, with a polyamine used in stoichiometric excess, especially DETA or TETA,
Mannich bases, especially phenalkamines, i.e. reaction products of phenols, especially cardanol, with aldehydes, especially formaldehyde, and polyamines,
aromatic polyamines such as, in particular, 4,4′-, 2,4’ and/or 2,2′-diaminodiphenylmethane, tolylene-2,4and/or -2,6-diamine, 3,5-dimethylthiotolylene-2,4and/or -2,6-tolylenediamine, 3,5-diethyl-2,4and/or -2,6-tolylenediamine, or
compounds having mercapto groups, especially liquid mercaptan-terminated polysulfide polymers, mercaptan-terminated polyoxyalkylene ethers, mercaptan-terminated polyoxyalkylene derivatives, polyesters of thiocarboxylic acids, 2,4,6-trimercapto-1,3,5-triazine, triethylene glycol dimercaptan or ethanedithiol.

The epoxy resin coating may contain further constituents, especially selected from the group consisting of fillers, accelerators, surface-active additives and stabilizers.

Suitable thinners are especially xylene, 2-methoxyethanol, dimethoxyethanol, 2-ethoxyethanol, 2-propoxyethanol, 2-isopropoxyethanol, 2-butoxyethanol, 2-phenoxyethanol, 2-benzyloxyethanol, benzyl alcohol, ethylene glycol, ethylene glycol dimethyl ether, ethylene glycol diethyl ether, ethylene glycol dibutyl ether, ethylene glycol diphenyl ether, diethylene glycol, diethylene glycol monomethyl ether, diethylene glycol monoethyl ether, diethylene glycol mono-n-butyl ether, diethylene glycol dimethyl ether, diethylene glycol diethyl ether, diethylene glycol di-n-butyl ether, propylene glycol butyl ether, propylene glycol phenyl ether, dipropylene glycol, dipropylene glycol monomethyl ether, dipropylene glycol dimethyl ether, dipropylene glycol di-n-butyl ether, 2,2,4-trimethylpentane-1,3-diol monoisobutyrate, diphenylmethane, diisopropylnaphthalene, mineral oil fractions, for example Solvesso® grades (from Exxon), alkylphenols such as tertbutylphenol, nonylphenol, dodecylphenol, cardanol (from cashew nut shell oil, containing 3-(8,11-pentadecadienyl)phenol), styrenized phenol, bisphenols, aromatic hydrocarbon resins, especially types containing phenol groups, alkoxylated phenol, especially ethoxylated or propoxylated phenol, especially 2-phenoxyethanol, adipates, sebacates, phthalates, benzoates, organic phosphoric or sulfonic esters or sulfonamides.

Preferred thinners have a boiling point of more than 200° C.

Particular preference is given to benzyl alcohol.

The epoxy resin coating preferably contains a particularly low content of thinners having a boiling point of less than 200° C., especially less than 1% by weight.

The epoxy resin coating preferably contains a low content of thinners having a boiling point of more than 200° C., especially less than 20% by weight, preferably less than 15% by weight.

Suitable accelerators are especially acids or compounds hydrolyzable to acids, especially organic carboxylic acids such as acetic acid, benzoic acid, salicylic acid, 2-nitrobenzoic acid, lactic acid, organic sulfonic acids such as methanesulfonic acid, p-toluenesulfonic acid or 4-dodecylbenzenesulfonic acid, sulfonic esters, other organic or inorganic acids, such as phosphoric acid in particular, or mixtures of the abovementioned acids and acid esters; nitrates such as calcium nitrate in particular; tertiary amines such as in particular 1,4-diazabicyclo[2.2.2]octane, benzyldimethylamine, α-methylbenzyldimethylamine, triethanolamine, dimethylaminopropylamine, imidazoles such as in particular N-methylimidazole, N-vinylimidazole or 1,2-dimethylimidazole, salts of such tertiary amines, quaternary ammonium salts, such as benzyltrimethylammonium chloride in particular, amidines, such as 1,8-diazabicyclo[5.4.0]undec-7-ene in particular, guanidines, such as 1,1,3,3-tetramethylguanidine in particular, phenols, especially bisphenols, phenolic resins or Mannich bases such as in particular 2-(dimethylaminomethyl)phenol, 2,4,6-tris(dimethylaminomethyl)phenol or polymers produced from phenol, formaldehyde and N,N-dimethylpropane-1,3-diamine, phosphites such as in particular di- or triphenyl phosphites, or compounds having mercapto groups.

Preference is given to acids, nitrates, tertiary amines or Mannich bases, especially salicylic acid, calcium nitrate or 2,4,6-tris(dimethylaminomethyl)phenol, or a combination of these accelerators.

Suitable surface-additives are especially defoamers, deaerating agents, wetting agents, dispersants, leveling agents or dispersed paraffin wax. The epoxy resin coating preferably contains a combination of such additives.

Suitable stabilizers are especially stabilizers against UV radiation or heat.

The epoxy resin coating optionally contains further auxiliaries and additives, especially
further reactive diluents, especially epoxidized soybean oil or linseed oil, compounds containing acetoacetate groups, especially acetoacetylated polyols, butyrolactone, carbonates, aldehydes, isocyanates or silicones having reactive groups,
polymers, especially polyamides, polysulfides, polyvinyl formal (PVF), polyvinyl butyral (PVB), polyurethanes (PUR), polymers having carboxyl groups, polyamides, butadiene-acrylonitrile copolymers, styrene-acrylonitrile copolymers, butadiene-styrene copolymers, homoor copolymers of unsaturated monomers, such as, in particular, ethylene, propylene, butylene, isobutylene, isoprene, vinyl acetate or alkyl (meth)acrylates, or chlorosulfonated polyethylenes, fluorine-containing polymers or sulfonamide-modified melamines,
rheology modifiers, especially antisettling agents,
adhesion improvers, especially organoalkoxysilanes,
flame-retardant substances, especially polybrominated diphenyl oxides or diphenyl ethers, phosphates such as in particular diphenyl cresyl phosphate, resorcinol bis(diphenyl phosphate), resorcinol diphosphate oligomer, tetraphenylresorcinol diphosphite, ethylenediamine diphosphate, bisphenol A bis(diphenyl phosphate), tris(chloroethyl) phosphate, tris(chloropropyl) phosphate, tris(dichloroisopropyl) phosphate, tris[3-bromo-2,2-bis(bromomethyl)propyl] phosphate, tetrabromobisphenol A, bis(2,3-dibromopropyl ether) of bisphenol A, brominated epoxy resins, ethylenebis(tetrabromophthalimide), ethylenebis(dibromonorbornanedicarboximide), 1,2-bis(tribromophenoxy)ethane, tris(2,3-dibromopropyl) isocyanurate, tribromophenol, hexabromocyclododecane, bis(hexachlorocyclopentadieno)cyclooctane or chloroparaffins, or
further additives, especially film-forming auxiliaries or biocides.

The epoxy resin coating preferably comprises at least two components that are stored in separate containers and are mixed with one another only shortly before application.

The resin component contains at least the liquid epoxy resin and any further compounds containing epoxy groups.

The hardener component contains at least one hardener for epoxy resins and optionally further compounds that are reactive with epoxy groups.

The further ingredients, especially the carbon nanotubes and zinc oxide, may be present as a constituent of the resin component and/or of the hardener component, or as separate components. Carbon nanotubes dispersed in a liquid containing epoxy groups are preferably a constituent of the resin component.

Preference is given to an epoxy resin coating comprising
a resin component containing at least one liquid epoxy resin, carbon nanotubes, a zinc oxide, at least one defoamer, and optionally at least one thinner, especially benzyl alcohol, and
a hardener component comprising at least one amine having at least three amine hydrogens, optionally at least one further amine having at least four amine hydrogens, optionally at least one thinner, especially benzyl alcohol, and optionally at least one accelerator.

The epoxy resin coating preferably contains the carbon nanotubes already mentioned in the amount already mentioned, and the zinc oxides already mentioned, especially aluminum-doped zinc oxide, in the amounts already mentioned.

The epoxy resin coating is preferably largely free of nontransparent fillers such as calcium carbonate, barite, talc, ground quartz, kaolin, cement or carbon black, and pigments such as titanium dioxide, iron oxide or chromium oxide. In particular, it contains less than 0.1% by weight of such fillers or pigments.

The epoxy resin coating preferably contains less than 0.1% by weight of fillers or pigments other than carbon nanotubes and zinc oxide; in particular, it is free of fillers or pigments other than carbon nanotubes and zinc oxide.

The epoxy resin composition is preferably not water-based and contains only a small content of water, preferably less than 5% by weight, in particular less than 1% by weight, of water. Such a coating is particularly robust with respect to moisture.

However, it is also possible that the epoxy resin coating contains a higher content of water. In particular, the resin component or hardener component or both may be water-based.

A particularly preferred epoxy resin coating contains
at least one liquid epoxy resin,
at least one hardener for epoxy resins,
0.001% to 0.01% by weight of carbon nanotubes and
1% to 3% by weight of zinc oxide, especially aluminum-doped zinc oxide, based on the overall coating.

In particular, it contains less than 0.1% by weight of fillers or pigments other than carbon nanotubes and zinc oxide, based on the overall coating.

Such a coating enables high transparency coupled with good electrical conductivity.

In the epoxy resin coating, the ratio of the number of groups reactive toward epoxy groups relative to the number of epoxy groups is preferably within a range from 0.5 to 1.5, in particular 0.7 to 1.2.

The resin component and the hardener component of the epoxy resin composition are stored in separate containers. A suitable container for storage of the resin component or the hardener component is especially a bucket, a hobbock, a drum, a pouch or a cartridge. The components are storable, meaning that they can be stored prior to use for several months up to one year or longer without any change in their respective properties to a degree relevant to their use. For the use of the epoxy resin coating, the components are mixed with one another shortly before or during application. The mixing ratio between the resin component and the hardener component is preferably chosen such that the groups of the hardener component that are reactive toward epoxy groups are in a suitable ratio to the epoxy groups of the resin component, as described above. In parts by weight, the mixing ratio between the resin component and the hardener component is typically in the range from 1:10 to 10:1, preferably 1:10 to 10:1.

The components are mixed by means of a suitable method; this mixing may be done continuously or batchwise. If the mixing does not immediately precede the application, it must be ensured that not too much time passes between mixing the components and the application thereof and that application takes place within the pot life. Mixing takes place in particular at ambient temperature, which is typically within a range from about 5 to 40° C., preferably about 10 to 35° C.

Curing by chemical reaction begins with the mixing of the two components. The primary and secondary amino groups, and any further groups present that are reactive toward epoxy groups, react with the epoxy groups, resulting in ring opening (addition reaction) thereof. As a result primarily of this reaction, the epoxy resin coating polymerizes and thereby cures.

The curing preferably proceeds at ambient temperature and typically extends over a few hours to days. The duration depends on factors including the temperature, the reactivity of the constituents, the stoichiometry thereof, and the presence of accelerators.

In the freshly mixed state, the epoxy resin coating has low viscosity. The viscosity at 23° C. 5 minutes after the components have been mixed is preferably within a range from 100 to 3,000 mPas, preferably 200 to 2,000 mPas, in particular 200 to 1,000 mPa·s, measured using a cone-plate viscometer at a shear rate of 100 s⁻¹.

The epoxy resin coating is applied to at least one substrate, the following substrates being particularly suitable:
concrete, mortar, cement screed, fiber cement, brick, tile, plaster, natural rocks such as granite or marble, or sand, especially electrically conductive quartz sand;
repair compounds or leveling compounds based on PCC (polymer-modified cement mortar) or ECC (epoxy resin-modified cement mortar);
metals or alloys such as aluminum, iron, steel, copper, other nonferrous metals, including surface-finished metals or alloys such as galvanized or chrome-plated metals;
asphalt or bitumen;
plastics, such as rigid and flexible PVC, polycarbonate, polystyrene, polyester, polyamide, PMMA, ABS, SAN, epoxy resins, phenolic resins, PUR, POM, TPO, PE, PP, EPM or EPDM, in each case untreated or surface-treated, for example by means of plasma, corona or flames;
fiber-reinforced plastics, such as carbon fiber-reinforced plastics (CFRP), glass fiber-reinforced plastics (GFRP), and sheet molding compounds (SMC);
coated or painted substrates, especially painted tiles, coated concrete, powder-coated metals or alloys;
coatings, paints or varnishes, especially coated floors that have been overcoated with a further floor covering layer.

If required, the substrates can be pretreated prior to application, especially by physical and/or chemical cleaning methods or the application of an activator or a primer.

The freshly mixed epoxy resin coating is applied, within its pot life, to the surface of a substrate in a layer thickness of about 0.1 to 1 mm, preferably 0.3 to 0.7 mm, typically at ambient temperature. It is applied especially by pouring onto the substrate to be coated and then spreading it evenly using, for example, a doctor blade or a rubber squeegee. It may also be applied with a brush, a roller or a spiked roller. Curing typically gives rise to homogeneous, glossy, nontacky, transparent films of high hardness that have good adhesion to a wide variety of different substrates, especially also quartz sand.

The invention further provides the cured, electrically conductive epoxy resin coating obtained from the mixed epoxy resin coating.

The cured epoxy resin coating in a layer thickness in the range from 0.3 to 1 mm preferably has an electrical resistance to ground, determined according to DIN EN 61340-4-1, in the range of > 5·10⁴ ohms and < 10⁹ ohms.

The cured epoxy resin coating is transparent. In a layer thickness of 0.5 mm on glass, it preferably has absorption at 665 nm, determined by UV-vis spectroscopy, of not more than 0.7, preferably not more than 0.6, especially not more than 0.5. In a layer thickness of 0.5 mm on glass, it also preferably has absorption at 430 nm, determined by UV-vis spectroscopy, of not more than 1.0, preferably not more than 0.9, especially not more than 0.8. Such a coating is particularly suitable as transparent seal for electrostatically dissipative floors, especially also for floors over which electrically conductive quartz sand has been scattered, with maintenance of good visibility of the color and structure of the sand and achievement of a highly esthetic surface.

The epoxy resin coating of the invention is thus preferably in contact with electrically conductive quartz sand after curing.

A suitable electrically conductive quartz sand is a quartz sand coated with a conductive synthetic resin, especially having a grain size in the range from 0.1 to 1.3 mm. Such quartz sands are commercially available, for example as Granucol® Conduct 2.0 (from Dorfner).

The epoxy resin coating of the invention is preferably used as a constituent of an electrostatically dissipative floor system. Such a floor system is especially laid in production halls or rooms where uncontrolled electrostatic discharges are problematic. These are especially rooms where electronic components are produced, stored or used, or where highly sensitive measurement systems are operated, or where combustible liquids or explosives are handled or stored, and especially climate-controlled rooms having particularly low humidity and particularly few particles in the atmosphere, such as cleanrooms, radiological facilities or operating rooms.

The invention thus further provides an electrostatically dissipative floor system comprising, from the bottom upward,
(i) at least one substrate,
(ii) optionally at least one epoxy resin primer,
(iii) at least one grounded electrical conductor system,
(iv) at least one epoxy resin coating,
(v) optionally at least one distributed filler, and
(vi) at least one transparent seal,
characterized in that the seal is an electrically conductive epoxy resin coating containing carbon nanotubes and at least one zinc oxide, as described above.

The electrostatically dissipative floor system preferably has an overall electrical resistance to ground, determined according to DIN EN 61340-4-1, in the range of > 5·10⁴ ohms and < 10⁹ ohms.

A suitable substrate (i) is especially concrete, optionally pretreated by means of grinding, sandblasting or shotblasting, or mortar, cement screed, fiber cement, brick, tile, gypsum, natural stones such as granite or marble, asphalt, or repair or leveling compounds based on PCC (polymer-modified cement mortar) or ECC (epoxy resin-modified cement mortar). Preference is given to concrete, mortar or cement screed.

The substrate is preferably coated with at least one epoxy resin primer (ii). This is preferably of low viscosity and largely free of fillers. It especially serves to solidify the substrate, to close any pores and to ensure good adhesion between the substrate and the further layers. The primer is typically distributed on the substrate with a brush, a roller or a rubber squeegee. Application is effected in one or more layers, typically in an amount in the range from 0.2 to 0.5 kg/m². Commercially available products that are suitable for the purpose are, for example, Sikafloor®-150, Sikafloor®-151, Sikafloor®-160 or Sikafloor®-161 (all from Sika).

If the substrate is uneven, after the priming, the surface can be leveled by troweling with a sand-filled epoxy resin composition.

A grounded conductor system (iii) is laid onto the optionally primed and optionally leveled substrate. For the grounding, preference is given to drilling holes in the floor and securing protruding metal screws therein. A mesh of copper wires or copper ribbons is preferably laid on the screws, these being in contact with the screws, for example via metal washers that have been placed on. The equipment for this purpose and an exact description for the installing is provided, for example, in the commercially available Sikafloor® conductive set (from Sika) According to the separation of the copper wires or ribbons and the grounding screws and the type of coating (iv), what is called a conductive film is additionally applied to this installation, which ensures electrical conduction between the copper wires or ribbons. Suitable conductive films are especially highly conductive epoxy resin coatings, for example Sikafloor®-220 W Conductive (from Sika).

The electrical conductor system preferably comprises at least a grounded copper wire or a grounded copper ribbon and optionally at least one electrically conductive foil which is in contact therewith and has an electrical resistance of < 10⁴ ohms.

At least one epoxy resin coating (iv) is subsequently applied to the electrical conductor system. This epoxy resin coating preferably has an electrical resistance to ground in the range of > 5·10⁴ ohms and < 10⁹ ohms. Suitable epoxy resin coatings (iv) are all kinds of dissipative epoxy resin coatings. Especially suitable are optionally pigmented coatings containing conductive substances selected from the list consisting of carbon nanotubes, aluminum-doped zinc oxide, metal powder, carbon fibers, carbon black, graphite and ionic liquids. Also suitable are transparent epoxy resin coatings containing carbon nanotubes and at least one zinc oxide, as described above. The epoxy resin coating (iv) is applied to the conductor system in one or more layers, especially in a layer thickness in the range from 0.1 to 5 mm, preferably 0.2 to 3 mm. The epoxy resin coating (iv) is preferably applied in just one layer in an amount in the range from 0.2 to 3 kg/m², preferably 0.3 to 2.5 kg/m².

The epoxy resin coating may be filled with a filler (v) which is sprinkled in during the pot life, suitable fillers being ground quartz and/or quartz sand in particular. The properties of this filler may be such that it mainly sinks into the coating and consolidates the epoxy resin coating.

The filler used is preferably at least one electrically conductive quartz sand, as described above, and the epoxy resin coating (iv) is scattered with an excess thereof within the pot life. After curing, the excess sand is removed, giving a rough surface with protruding grains of sand embedded into the coating. Such a surface is particularly slip-resistant.

Subsequently, the seal (vi), corresponding to the above-described epoxy resin coating of the invention containing carbon nanotubes and at least one zinc oxide, is applied to the epoxy resin coating that has optionally been scattered with filler.

The seal is especially applied in an amount in the range from 0.1 to 1 kg/m², especially 0.2 to 0.7 kg/m².

In a preferred embodiment of the floor system, the epoxy resin coating (iv) is pigmented and hence not transparent. An epoxy resin coating suitable for the purpose is commercially available, for example as Sikafloor®-235 ESD (from Sika). It is preferably scattered with an excess of electrically conductive quartz sand.

In a particularly preferred embodiment of the floor system, the epoxy resin coating (iv) is transparent and has been scattered with an excess of electrically conductive quartz sand. Especially suitable for this purpose is the transparent, electrically conductive epoxy resin coating containing carbon nanotubes and at least one zinc oxide, as also present as seal (vi). Such a floor system is particularly easily and rapidly applied, and meets the highest esthetic demands.

The floor system of the invention is preferably part of a building or of a room in a building. In particular, the floor system is present wherever uncontrolled discharges can cause damage. These are especially rooms where electronic components are produced, stored or used, or where highly sensitive measurement systems are operated, or where combustible liquids or explosives are handled or stored, and especially climate-controlled rooms having particularly low humidity and particularly few particles in the atmosphere, such as cleanrooms, radiological facilities or operating rooms.

### EXAMPLES

Working examples are adduced hereinafter, which are intended to further elucidate the invention described. The invention is of course not limited to these described exemplary embodiments.

“AHEW” stands for amine hydrogen equivalent weight.

“EEW” stands for epoxy equivalent weight.

“Standard climatic conditions” (“SCC”) refers to a temperature of 23 ± 1° C. and a relative air humidity of 50 ± 5%.

The chemicals used were unless otherwise stated from Sigma-Aldrich Chemie GmbH.

Substances and abbreviations used:

| | |
|---|---|
| CNT Dispersion 10%: | Dispersion of 10% by weight of single wall carbon nanotubes in alkyl glycidyl ether, EEW 266 g/mol (Tuball® |
| | Matrix Beta 207, from OCSiAl) |
| Al-doped ZnO | Aluminum-doped zinc oxide (ZnO-23K, from Itochu) |
| Araldite® GY 250: | Bisphenol A diglycidyl ether, EEW 187 g/mol (from Huntsman) |
| Sikafloor®-150: | 2-component epoxy resin primer (from Sika) |
| Sikafloor®-151: | 2-component epoxy resin primer (from Sika) |
| Sikafloor®-220 W Conductive: | 2-component, water-based, highly electrically conductive, black epoxy resin coating |
| Sikafloor®-235 ESD: | 2-component, electrostatically dissipative, pigmented, self-leveling epoxy resin coating |
| Conductive quartz sand: | Synthetic resin-coated, electrically conductive quartz sand 0.3 to 0.8 mm (Granucol® Conduct 2.0, from Dorfner) |

### Production of Electrically Conductive Epoxy Resin Coatings

### Examples 1 to 6:

For each example, the ingredients of the resin component specified in table 1 were mixed in the specified amounts (in parts by weight) by means of a centrifugal mixer (SpeedMixer™ DAC 150, FlackTek Inc.) and stored with exclusion of moisture.

Also produced for these examples was the following hardener component, by mixing the following ingredients by means of the centrifugal mixer and storing it with exclusion of moisture.
7.8 parts by weight of 1-amino-3-aminomethyl-3,5,5-trimethylcyclohexane (Vestamin® IPD, from Evonik),
2.7 parts by weight of 2,2(4),4-trimethylhexane-1,6-diamine (Vestamin® TMD, from Evonik),
1.5 parts by weight of N-benzylethane-1,2-diamine,
1.0 part by weight of the adduct of 55 parts by weight of N-benzylethane-1,2-diamine and 45 parts by weight of bisphenol A diglycidyl ether,
3.6 parts by weight of polyoxypropylenediamine having average molecular weight 230 g/mol (Jeffamine® D-230, from Huntsman), and
8.4 parts by weight of benzyl alcohol.

The two components were then processed using the centrifugal mixer into a homogeneous liquid and this was tested immediately as follows:

Viscosity was measured 5 min after the resin component and the hardener component had been mixed by means of a cone-plate viscometer at a shear rate of 100 s⁻¹ and a temperature of 23° C.

Shore D hardness was determined to DIN 53505 on two cylindrical test specimens (diameter 20 mm, thickness 5 mm), with storage under standard climatic conditions at 8° C. and 80% relative humidity. Hardness was measured here after 1 day, 2 days, 7 days and 14 days.

In order to determine transparency, a particle board that has been painted blue was coated with 0.5 kg/m² of the respective example and, after 7 days under standard climatic conditions, the appearance of the transparently sealed board was assessed. A “nice” surface was one that was shiny and nontacky without specks, cloudiness or patterns. The seal is described as “transparent” when the underlying blue color has good visibility and no color change. The appearance is described as “dark” or “very dark” when the blue colour appears darker through the coating. The appearance is described as “whitish” or “very whitish” when the blue colour appears cloudy and whitish through the seal.

As a measure of transparency, absorption was determined by UV-vis spectroscopy. For this purpose, a film was applied to a glass plate in a layer thickness of 500 µm and stored under standard climatic conditions for 7 days. Subsequently, absorption at 665 nm (red) and at 430 nm (blue) was determined on the coated glass plate in a UV-vis system (Cary 60 from Agilent Technologies). For determination of electrical resistance, a particleboard was primed with 0.3 kg/m² of Sikafloor®-150 and stored under standard climatic conditions for 24 h, then 0.1 kg/m² of Sikafloor®-220 W Conductive was applied, and the board was stored under standard climatic conditions for a further 24 h. 0.5 kg/m² of the respective epoxy resin coating was applied to the board thus coated and, after a curing time of 48 h under standard climatic conditions, electrical resistance to ground according to DIN EN 61340-4-1 of the coating was measured at 8 points. The results are reported in Table 1.

Viscosity, pot life and Shore D hardness were determined for example 2 only.

The values for the further examples 1 and 3 to 6 are within a similar range.

The examples designated “(Ref.)” are comparative examples.

TABLE 1

Composition and properties of examples 1 to 6

| | | | | | | |
|---|---|---|---|---|---|---|
| Example | 1 | 2 | 3 | 4 | 5 (Ref.) | 6 (Ref.) |
| Resin component: Araldite® GY 250 | 66.3 | 66.3 | 66.3 | 66.3 | 66.3 | 66.3 |
| CNT Dispersion 10% | 0.005 | 0.015 | 0.15 | 0.015 | - | - |
| Al-doped ZnO | 1.5 | 1.5 | 1.5 | 0.5 | 5.0 | 10.0 |
| Additives/defoamers | 1.7 | 1.7 | 1.7 | 1.7 | 1.7 | 1.7 |
| Benzyl alcohol | 5.5 | 5.5 | 5.5 | 5.5 | 5.5 | 5.5 |
| Curing agent component: | 25.0 | 25.0 | 25.0 | 25.0 | 25.0 | 25.0 |
| Viscosity (5′) [Pa·s] | n.d. | 0.5 | n.d. | n.d. | n.d. | n.d. |
| Pot life [min] 10° C. | n.d. | 60 | n.d. | n.d. | n.d. | n.d. |
| 20° C. | | 30 | | | | |
| 30° C. | | 20 | | | | |
| Shore D (1d SCC) | n.d. | 70 | n.d. | n.d. | n.d. | n.d. |
| (2d SCC) | | 78 | | | | |
| (7d SCC) | | 80 | | | | |
| (14d SCC) | | 80 | | | | |
| Shore D (1d 8°/80%) | n.d. | 8 | n.d. | n.d. | n.d. | n.d. |
| (2d 8°/80%) | | 57 | | | | |
| (7d 8°/80%) | | 76 | | | | |
| (14d 8°/80%) | | 79 | | | | |
| Appearance | nice, transparent | nice, transparent | nice, very dark | nice, dark | nice, whitish | nice, very whitish |
| Absorption at 665 nm | 0.60 | 0.44 | 0.75 | 0.28 | 1.25 | 1.74 |
| at 430 nm | 0.88 | 0.69 | 1.04 | 0.47 | 1.63 | 2.02 |
| Resistance [ohms] | | | | | | |
| Average: | 3.1·10¹⁰ | 1.5·10⁷ | 8.1·10⁴ | 3.0·10⁶ | 5.0·10⁶ | 7.1·10⁷ |
| Minimum: | 2.9·10¹⁰ | 3.0·10⁶ | 4.5·10⁴ | 4.1·10⁵ | 3.2·10⁵ | 7.9·10⁵ |
| Maximum: | 3.4·10¹⁰ | 3.3·10⁸ | 1.3·10⁵ | 1.0·10⁷ | 1.1·10⁷ | 1.810⁸ |

“n.d.” stands for “not determined”

### Production of Electrostatically Dissipative Floor Systems

### Example 7:

An area of 120 m² of polished indoor concrete floor was provided with an electrostatically dissipative floor system. During the installation, the substrate temperature was 18 to 20° C., the air temperature 20° C. to 21° C., and the air humidity 42% to 50%.

First of all, a layer of Sikafloor®-150 as primer was rolled on in an amount of 0.4 kg/m² and left to cure for 24 h.

Subsequently, unevenness was filled by application of Sikafloor®-151, with an additional 43% by weight of quartz sand, which was leveled with a trowel and left to cure of the 24 h.

Subsequently, grounding points and copper ribbons from a Sikafloor® conductive set were installed on the floor thus prepared according to the instructions, followed by the Sikafloor®-220 W Conductive coating, which was rolled on as a conductive film in an amount of 0.1 kg/m² (high electrical conductivity, guides electrostatic charges to the copper ribbons and grounds).

After 24 h of curing time, 1.3 kg/m² of Sikafloor®-235 ESD in the color RAL 7035 (light grey) was applied and scattered with an excess of 3.3 kg/m² of conductive quartz sand. After a curing time of 24 h, the excess sand was removed by means of a brush and vacuum cleaner.

The sanded rough surface was then transparently sealed with the electrically conductive epoxy resin coating from example 2 by distributing it in an amount of 0.4 kg/m² by means of a rubber squeegee and then rolling over it with a structured roller.

The seal had good distributability over the sanded surface and, after subsequent rolling, showed an even surface without streaks, bubbles, craters or other inhomogeneities. After curing, the floor system had a highly esthetic, hard, tack-free, transparent surface, through which the color of the sand and the light gray coating beneath had good visibility.

The electrical resistance to ground of the finished floor system was measured at 50 points to DIN EN 61340-4-1. The average, the minimum and the maximum are reported in table 2.

### Example 8:

An area of 55 m² of polished indoor concrete floor was provided with an electrostatically dissipative floor system. During the installation, the substrate temperature was 14 to 17° C., the air temperature 13° C. to 19° C., and the air humidity 49% to 66%.

First of all, a layer of Sikafloor®-151 as primer was rolled on in an amount of 0.4 kg/m² and left to cure for 24 h.

Subsequently, the conductive system consisting of the Sikafloor® conductive set of the Sikafloor®-220 W Conductive coating was laid as described for example 7.

After a curing time of 24 h, 0.5 kg/m² of the transparent, electrically conductive epoxy resin coating from example 2 was applied. For this purpose, the material was poured out, distributed with a rubber squeegee and rolled over with a roller.

Within 30 min after application, 3.0 kg/m² of conductive quartz sand was scattered over this layer in excess. After a curing time of 24 h, the excess sand was removed by means of a brush and vacuum cleaner.

The sanded surface was then transparently sealed with the electrically conductive epoxy resin coating from example 2 by distributing it in an amount of 0.4 kg/m² by means of a rubber squeegee and then rolling over it with a structured roller.

The seal had good distributability over the standard surface and, after subsequent rolling, showed an even surface without streaks, bubbles, craters or other inhomogeneities. After curing, the floor system had a highly esthetic, hard, tack-free, transparent surface, through which the color of the sand had good visibility.

The electrical resistance to ground of the finished floor system was measured at 30 points to DIN EN 61340-4-1. The average, the minimum and the maximum are reported in table 2.

TABLE 2

Construction and electrical resistance of examples 7 and 8

| | | |
|---|---|---|
| Example | 7 | 8 |
| Substrate: | polished concrete | |
| Primer: | Sikafloor®-150 | Sikafloor®-151 |
| Leveling | Sikafloor®-151 filled | |
| Conduction system: | Sikafloor® conductive set and Sikafloor®-220 W Conductive | |
| EP coating: | Sikafloor®-235 ESD RAL 7035 | Transparent coating from example 2 |
| Overscattered with: | Conductive quartz sand | |
| Seal: | Transparent coating from example 2 | |
| Resistance to ground: [ohms] | | |
| Average: | 1.0·10⁷ | 2.4·10⁵ |
| Minimum: | 4.5·10⁶ | 1.2·10⁵ |
| Maximum: | 1.4·10⁷ | 4.9·10⁵ |

1. A method comprising producing a transparent, electrically conductive epoxy resin coating with a combination of carbon nanotubes and at least one zinc oxide.

2. The method as claimed in claim 1, wherein the carbon nanotubes are present in an amount in the range from 0.001% to 0.01% by weight, based on the overall epoxy resin coating.

3. The method as claimed in claim 1, wherein the zinc oxide is an aluminum-doped zinc oxide.

4. The method as claimed in claim 1, wherein the zinc oxide is used in an amount in the range from 0.5% to 5% by weight, based on the overall epoxy resin coating.

5. An electrically conductive epoxy resin coating obtained from the method as claimed in claim 1, comprising
at least one liquid epoxy resin,
at least one hardener for epoxy resins,
carbon nanotubes, and
at least one zinc oxide.

6. The coating as claimed in claim 5, wherein it comprises
0.001% to 0.01% by weight of carbon nanotubes and
1% to 3% by weight of zinc oxide, based on the overall coating.

7. The coating as claimed in claim 6, wherein it contains, based on the overall coating, less than 0.1% by weight of fillers or pigments other than carbon nanotubes and zinc oxide.

8. A cured electrically conductive epoxy resin coating obtained from the mixed epoxy resin coating as claimed in claim 5.

9. The epoxy resin coating as claimed in claim 8, wherein it has, in a layer thickness in the range from 0.3 to 1 mm, an electrical resistance to ground, determined according to DIN EN 61340-4-1, in the range of > 5·10⁴ ohms and < 10⁹ ohms.

10. The epoxy resin coating as claimed in 8, wherein it has, in a layer thickness of 0.5 mm on glass, an absorption at 665 nm of not more than 0.7, determined by UV-vis spectroscopy.

11. The epoxy resin coating as claimed in claim 8, wherein it is in contact with electrically conductive quartz sand.

12. An electrostatically dissipative floor system comprising, from the bottom upward,

| | |
|---|---|
| (i) | at least one substrate, |
| (ii) | optionally at least one epoxy resin primer, |
| (iii) | at least one grounded electrical conductor system, |
| (iv) | at least one epoxy resin coating, |
| (v) | optionally at least one distributed filler, and |
| (vi) | at least one transparent seal, |

wherein the seal is an electrically conductive epoxy resin coating as claimed in claim 8.

13. The floor system as claimed in claim 12, wherein electrical resistance to ground, determined to DIN EN 61340-4-1, is in the range of > 5·10⁴ ohms and < 10⁹ ohms.

14. The floor system as claimed in claim 12, wherein the seal has been applied in an amount in the range from 0.1 to 1 kg/m².

15. The floor system as claimed in claim 12, wherein the epoxy resin coating (iv) is transparent and an excess of conductive quartz sand has been scattered over it.
